(19) United States
(12) Patent Application Publication
(10) Pub. No.: US 2004/0002792 A1
(43) Pub. Date: Jan. 1, 2004

(54) Lighting energy management system and method

(75) Inventor: Marc O. Hoffknecht, Markham (CA)

Correspondence Address: BERESKIN AND PARR, SCOTIA PLAZA, 40 KING STREET WEST-SUITE 4000 BOX 401, TORONTO, ON, M5H 3Y2, CA

(73) Assignee: Encelium Technologies Inc., Toronto (CA)

(21) Appl. No.: 10/425,631

(22) Filed: Apr. 30, 2003

Related U.S. Application Data
(60) Provisional application No. 60/392,033, filed on Jun. 28, 2002.

(51) Int. Cl. G05B 11/01

(52) U.S. Cl. 700/295; 315/294; 324/699; 700/11

(57) ABSTRACT

An lighting energy management system and method for controlling lighting fixtures in a building, uses lighting fixtures, photo and occupancy sensors, personal lighting commands and an energy control unit. The energy control unit receives information from the photo and occupancy sensors and the personal controller and determines an optimal brightness command for each lighting fixture using a coordinated system of zone and fixture objects. Each zone object is associated with a building zone and each fixture object is associated with a light fixture. Each zone object ensures that lighting fixture lighting level is adjusted when a physical zone is unoccupied. Each fixture object uses sensors and personal inputs to determine a desired brightness level and uses a load shedding and daylight compensation to determine a daylight adjusted brightness level. The energy control unit determines an optimal brightness command based on these levels to minimize the energy required by the lighting fixtures.

This application claims priority from provisional U.S. patent application Ser. No. 60/392,033 filed Jun. 28, 2002.

### FIELD OF THE INVENTION

This invention relates to an energy management system and method and more particularly an energy management system and method for reducing energy usage for lighting.

### BACKGROUND OF THE INVENTION

Energy usage (typically expressed in kWh), in simple terms equals the actual power consumption (kW) multiplied by the duration (hours) of operation. Various existing strategies are currently used to minimize energy usage. Various existing strategies are currently available to accomplish efficient usage of electric lighting. Each of these strategies reduce the “on-time” of lighting and/or reduce the power consumption at a particular moment in time.

For example, task tuning allows for light levels to be adjusted to suit the particular task at hand. It is often the case that work spaces are over-lit after a lighting upgrade. Additionally, lighting designers often provide for too much lighting in an area, as the exact use of a particular area may change over time. Task tuning is often employed to deal with the excessive lighting that may be present in an area. IESNA (Illuminating Engineering Society of North America) recommends the maintenance of certain illumination in areas where certain tasks are to be performed. However, it is often the case that many individuals prefer lighting levels lower than those that have been recommended. It is therefore desired that occupants have manual control of the illumination levels so they can adjust them to best suit their desires. As a result of occupants often employing lower levels of illumination through manual controls than those that are recommended, energy consumption is reduced. Another energy reduction approach is occupancy control. This ensures that certain areas are lit only when they are in use. A typical occupancy controller turns off the lights approximately 10 minutes after it has last detected activity. Occupancy can be monitored in various ways with infrared sensors and ultrasound sensors being two of the ways.

Time scheduling is another way to reduce the “on” time of a lighting system in order to reduce energy consumption. Time scheduling allows for lights to be switched on and off based on a schedule that is usually determined by time-of-day and type-of-day (weekend, holiday, etc) criteria.

Daylight harvesting is a strategy employed to attempt to reduce energy consumption when dealing with lighting. Daylight harvesting allows for incoming natural light to be measured and the illumination of interior lights to be increased or decreased accordingly. As the natural light in an area increases, the illumination level of light may be decreased accordingly, which allows for the maintenance of the same overall level of lighting.

Load shedding is a strategy employed to dynamically reduce power consumption. Aside from the actual energy consumed, often a supplementary charge is billed for the maximum power consumption recorded during a month (“peak demand”), even though the duration of such peaks is generally very short. Alternatively, energy might be billed at constantly varying rates in deregulated markets, with such rates showing price spikes in times of power supply shortages. If it is determined that energy prices are temporarily excessively high or that current power consumption of the system unnecessarily affects the “peak demand”, load shedding employs a smooth and gradual reduction in illumination levels to a degree which should not be noticeable by occupants, which thus reduces power consumption.

However, combining these strategies is a difficult and complex matter since the combination of these energy reduction strategies can often result in undesirable effects. As a simple illustration, consider a case where a user wants to manually reduce the brightness of lighting in an area using manual controls. When this is completed, an associated lighting sensor utilized by the daylight harvesting would sense a reduction in illumination and attempt to counteract this, resulting in an inefficient system.

### SUMMARY OF THE INVENTION

The invention provides in one aspect, a lighting energy management system for controlling the operation of a plurality of lighting fixtures in a building in order to minimize the energy required by said lighting fixtures, said building having a plurality of physical zones, said energy management system comprising:

(a) at least one photo sensor for measuring a brightness level in the vicinity of the photo sensor and at least one occupancy sensor for determining whether a physical zone is occupied;

(b) a communication bus coupled to each of the lighting fixtures, photo sensors and occupancy sensors to provide data communication therebetween;

(c) a personal controller module coupled to the communication bus for generating personal lighting commands;

(d) an energy control unit coupled to the communication bus for receiving information from the photo sensors and occupancy sensors and said personal controller, determining an optimal brightness command for each lighting fixture, and providing each optimal brightness command to each lighting fixture over the communication bus, said energy control unit being adapted to store and maintain a plurality of zone objects and a plurality of fixture objects, wherein each zone object is associated with a physical or logical zone of the building and wherein each fixture object is associated with a lighting fixture and where:

(i) each said zone object has an occupancy controller module for receiving data from said at least one occupancy sensor, said occupancy controller module being adapted to selectively provide an adjustment command to associated lighting fixtures which are within the physical zone of the building associated with said zone object, so that the optimal brightness command generated by the energy control unit takes into account whether a physical zone is determined to be unoccupied;

(ii) each fixture object being associated with a zone object according to whether said associated lighting fixture is within the physical or logical zone of the building associated with the zone object, and having a switching control and preset module for obtaining data from said associated zone object, a personal controller module, to determine a desired brightness level, a load shedding module for using the desired brightness level and a load shedding factor to determine a target brightness level, and a daylight compensation module for using the target brightness level along with data from said photo sensors to determine the optimal brightness command which takes into account daylight illumination; and

(e) said energy control unit distributing the optimal brightness command received from each said fixture objects to each said associated lighting fixture, such that the energy required by the light fixtures is minimized according to various energy management strategies and personal lighting preferences.

The invention provides in another aspect, a method of controlling the operation of a plurality of lighting fixtures in a building in order to minimize the energy required by said lighting fixtures, said building having a plurality of physical zones, said energy management method comprising:

(a) determining photo sensor data using at least one photo sensor, determining occupancy data within at least one of the physical zones using at least one occupancy sensor, and providing said photo sensor data and occupancy data over a communication bus;

(b) providing signals to and from each of said lighting fixtures over the communication bus;

(c) obtaining at least one personal lighting command and providing said at least one personal lighting command over the communication bus;

(d) receiving photo sensor data, occupancy data and said at least one personal lighting commands over said communication bus, and storing and maintaining a plurality of zone objects and a plurality of fixture objects, wherein each zone object is associated with a zone of the building, each fixture object is associated with a lighting fixture and each fixture object is associated with a zone object according to whether said associated lighting fixture is within the zone of the building associated with the zone object such that:

(i) each said zone object receives occupancy sensor data and selectively provides an adjustment command to at least one associated lighting fixture, so that the optimal brightness command reduces at least one associated lighting fixture in brightness when the zone is determined to be unoccupied;

(ii) each said fixture object receives at least one of a personal lighting command and data from said associated zone object, determines a desired brightness level, uses the desired brightness level and a load shedding factor to determine a target brightness level, uses the target brightness level along with photo sensor data to determine an optimal brightness command which takes into account daylight illumination; and

(e) distributing the optimal brightness command received from each of said fixture objects to each said associated lighting fixtures, such that the energy required by the light fixtures is minimized according to several individual energy management strategies and personal lighting preferences.

The invention provides in another aspect a method of determining the relative physical location of a plurality of device nodes interconnected with cabling within an electrical system and representing said relative physical location using a branch mapping that represents cable lengths between pairs of nodes, said method comprising:

(a) measuring the power supply voltage at each node;

(b) selectively and alternately increasing the current consumption for each node by a predetermined amount;

(c) determining the corresponding decrease in the power supply voltage within said node and said other nodes that results due to resistive losses within the cabling; and

(d) determining the physical cable length between each pair of said nodes and the relative physical location of each of said nodes.

The invention provides in another aspect a method of determining the relative physical location of a plurality of device nodes interconnected with cabling within an electrical system and representing said relative physical location, said method comprising:

(a) measuring the power supply voltage at each device node;

(b) sorting said power supply measurements and determining a sequence of physical installation locations based on the sorted power supply measurements;

(c) comparing said sequence with a likely sequence of installation based on the physical construction of said electrical system;

(d) determining the relative physical location of each of said nodes.

The invention provides in another aspect a system for interconnecting a plurality of devices, said system including a communication bus and a plurality of input/output modules coupled to the communication bus and to each device, each said input/output module being adapted to provide an adaptive interface between the communication bus and each device, each of said input/output modules comprising:

(i) a device identifier module for detecting an electrical characteristic associated with the device and determining the identity of the device based on said detected electrical characteristic; and

(ii) a universal interface module coupled to the device identifier module, said universal interface module being adapted to communicate data between said communication bus and said device, according to the identity of the device as determined by the device identifier module.

The invention provides in another aspect a method of interconnecting a plurality of electrical devices, said system including a communication bus and a plurality of input/output modules coupled to the communication bus and to each device, each said input/output module being adapted to provide an adaptive interface between the communication bus and each device, said method comprising:

(i) detecting an electrical characteristic associated with the device and determining the identity of the device based on said detected electrical characteristic; and

(ii) communicating data between said communication bus and said device, according to the identity of the device as determined by the device identifier module.

The invention provides in another aspect an energy management system for controlling the operation of a plurality of energy consuming units in a building in order to minimize the energy required by said energy consuming units, said building having a plurality of physical zones, said energy management system comprising:

(a) a sensor located in a physical zone of the building, said sensor being selected from the group consisting of a computer program, a wall-mounted controller device, a fire alarm, a security alarm, a security sensor, an access-control device, and a telephone, each of which provides an operational signal; and

(b) an occupancy controller module associated with the physical zone of the building coupled to the sensor for receiving data concerning the occupancy of a physical zone, said occupancy controller module being adapted to detect said operational signal associated with said sensor and to determine whether a physical zone is occupied based on said operational signal.

The invention provides in another aspect a method of performing daylight compensation within a lighting energy management system wherein the daylight contribution to a particular lighting level as read by a photo sensor associated with at least one lighting fixture is determined by:

(i) operating each of the lighting fixtures at a range of brightness levels when there is no adverse change in available daylight;

(ii) compiling the readings of said photo sensor for each brightness level of each lighting fixture into a reading profile for the photo sensor; and

(iii) for the particular lighting level, using said reading profile to remove the photo sensor readings associated with the brightness level for each lighting fixture from said lighting level, such that for the particular lighting level, the daylight contribution can be determined;

(iv) adjusting the light provided by each lighting fixture to compensate for the daylight contribution as determined in step (iii).

The invention provides in another aspect a method of controlling the operation of a plurality of energy consuming units in a building using a plurality of local switching devices that reduces switching stress due to excessive inrush currents normally associated with said energy consuming units and reduces energy consumption, each energy consuming unit having an associated power supply and an inrush current limiting impedance, said method comprising:

(a) distributing the centralized switching control by electrically coupling each of said local switching devices between an associated energy consuming unit and an associated power supply;

(b) locating each of said switching devices in close proximity to each of said energy consuming units so as to increase inrush current limiting impedance associated with said energy consuming unit;

(c) communicating a connectivity command to said switching devices over a communication bus; and

(d) selectively switching each energy consuming unit using said switching-device based on the connectivity command.

The invention provides in another aspect a method of installing a lighting control device and associated data communication wiring and power wiring within a lighting fixture cover having knock-out aperture formed within, said method comprising:

(a) installing said data communication wiring outside said lighting fixture cover above the position of said knock-out aperture;

(b) installing said power wiring within said fixture cover below the position of said knock-out aperture; and

(c) positioning and removeably securing said lighting control device within said knock-out aperture such that said lighting control device represents an electrical barrier between the inside of said light fixture cover and the outside of said light fixture cover.

Further aspects and advantages of the invention will appear from the following description taken together with the accompanying drawings.

### BRIEF DESCRIPTION OF THE DRAWINGS

In the accompanying drawings:

FIG. 1 is a schematic diagram depicting the elements of the lighting energy management system of the present invention;

FIG. 2 is a graphical representation of a first aspect of the user interface of the lighting energy management system of FIG. 1;

FIG. 3 is a graphical representation of a second aspect of the user interface of the lighting energy management system of FIG. 1;

FIG. 4 is a flowchart depicting the stages of the lighting energy management system of FIG. 1;

FIG. 5 is a schematic diagram representing the architecture layers of the lighting energy management system of FIG. 1;

FIG. 6 is a schematic depicting the zone objects used in the distribution layer of the lighting energy management system of FIG. 1;

FIG. 7 is a schematic diagram depicting the fixture objects and modules in the device layer of the lighting energy management system of FIG. 1;

FIG. 8 is schematic diagram depicting the information flow and interaction between the stages of the lighting energy management system of FIG. 1;

FIG. 9 is a schematic diagram depicting the information flow and interaction of zone and fixture objects from both architectural layers of the lighting energy management system of FIG. 1;

FIG. 10 is a schematic diagram of the universal input/output interface of the lighting energy management system of FIG. 1;

FIG. 11 is a schematic diagram depicting the connectivity ability of the universal input/output module of the lighting energy management system of FIG. 1;

FIGS. 12A to 12E are schematic diagrams that illustrate an example using nodes for the addressing method of the lighting energy management system of FIG. 1;

FIGS. 13A and 13B are schematic diagrams that illustrate an example using nodes for a simplified addressing method of the lighting energy management system of FIG. 1; and

FIGS. 14A and 14B are graphs that illustrate the load profile and the proportional contribution towards energy savings of each aspect of the lighting energy management system of FIG. 1.

### DETAILED DESCRIPTION OF THE INVENTION

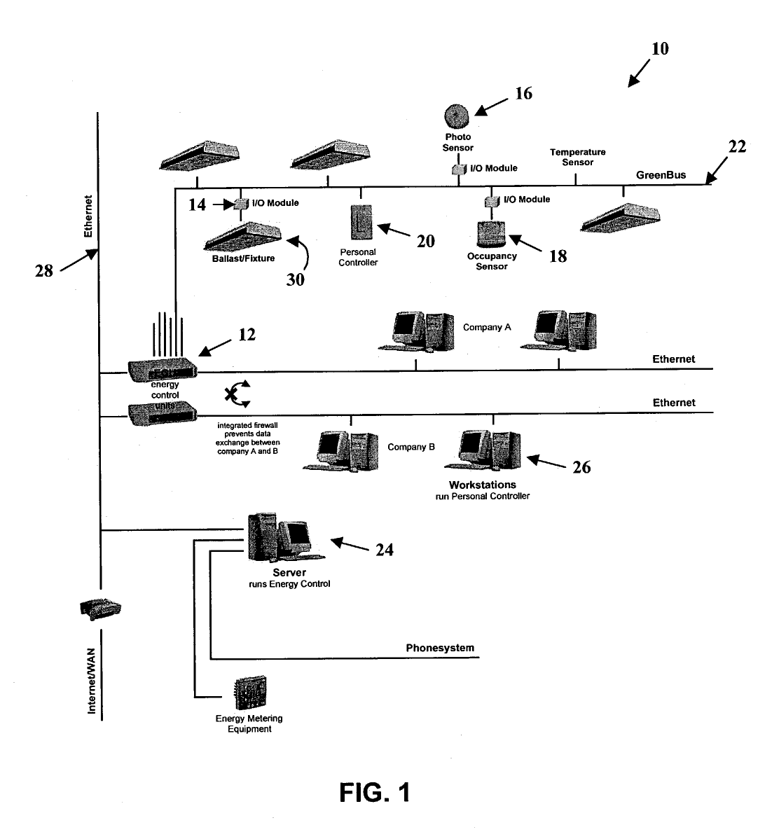

FIG. 1 is a diagram of a lighting energy management system 10 made in accordance with a preferred embodiment of the invention. Energy management system 10 contains energy control units (ECU) 12, universal input/output modules 14, photo sensors 16, occupancy sensors 18, personal controllers 20, communication bus 22, energy control module 24, personal controller module 26, communication network 28 and lighting fixtures 30.

Energy control unit 12 is a hardware device that collects, processes and distributes energy control information and is typically installed on each floor of a building. Energy control unit 12 collects information from photo sensors 16, occupancy status from occupancy sensors 18 and information from personal controllers 20, personal controller module 26, and preset information with regards to time scheduling and task tuning strategies. It is also able to receive information from other devices within energy management system 10 as well as other control systems that may be in operation in the building (e.g. the building automation system). Based on all of this input data, energy control unit 12 determines the optimal brightness level for each individual ballast/fixture 30, it distributes this brightness level to the appropriate lighting fixture 30 on the communication bus 22 via universal input/output module 14. Energy control unit 12 collects all the data that influences the brightness of a lighting fixture 30, and processes and prioritizes this data in determining an optimal brightness level for each lighting fixture 30. The specific details of how this determination is made will be described below.

Universal input/output module 14 is a small hardware device that connects the communication bus 22 to all lighting fixtures 30, photo sensors 16, occupancy sensors 18, and other peripheral devices. Universal input/output module 14 has a universal three-wire interface that detects the type of device which is attached to it and which automatically generates the correct interface for that device. The specific connectivity aspects of input/output module 14 will be described in further detail below.

Photo sensor 16 measures the amount of light that is present in an area (i.e. photo sensor data) and passes this information along communication bus 22 to energy control unit 12. Photo sensor data is one of the types of information that energy control unit 12 uses to determine the optimal brightness level for a particular lighting fixture 30. Photo sensor 16 can be implemented by a conventional photo sensor such as those manufactured by PLC Multipoint, which use a photosensitive element and generates a voltage depending on the incident light. The specific method by which the information from photo sensor 16 is used is described in further detail below.

Lighting energy management system 10 uses a plurality of physical occupancy sensors 18 as well as other indicators of occupancy as will be explained below, to determine whether an area within a building requires lighting. The occupancy data detected by occupancy sensor 18 is sent via communication bus 22 to energy control unit 12. Energy control unit 12 uses the occupancy data (along with various other data) from occupancy sensor 18 to determine the optimal brightness level for lighting fixture 30 as will be described.

Personal controller 20 is similar to a conventional manual dimming switch and provides a user with a manual method of turning lights on or off, setting personal light levels within an area and dimming lights. Personal controller 20 communicates with energy control unit 12 through communication bus 22. Personal controller 20 is a control interface which does not contain electronics that directly allow it to control the lighting, it is a control interface which sends appropriate information to energy control unit 12, which results in personal controller being lower in cost than typical dimming switches.

Communication bus 22 allows for communication between the various devices (e.g. lighting fixture 30, photo sensor 16, occupancy sensor 18) and energy control unit 12. While it is possible to run communication wiring from energy control unit 1 2 to each device, this would be very inefficient. Communication bus 22 allows for the addressing of, and communication with, all lighting fixtures 30 and the various devices that are used in energy management system 10.

Energy controller module 24 runs on the central building personal computer/server and allows for monitoring of the building's energy consumption, control over all system parameters and system set up. The server/personal computer that hosts energy controller module 24 is also adapted to host a telephone interface application, which allows users to control lights by identifying themselves via a code and then inputting an appropriate command. Energy controller module 24 allows for the initialization and maintenance of system parameters such as user access codes, security features, and also to determine to what extent zones can be affected by load shedding via an easy to use graphical user interface (GUI). The GUI allows for viewing of an actual building floor plan as well as lighting relating information superimposed in real time, where information regarding individual lighting fixtures 30 and other devices (e.g. photo sensors 16, occupancy sensors 18) can be seen. In the event of a physical reconfiguration/remodeling of a portion of a building, it is possible for energy management system 10 to be reconfigured through energy controller module 24 without any physical changes being required to the devices or wiring.

Energy controller module 24 also monitors both past and current energy consumption, and calculates short-term energy consumption predictions. The prediction that is calculated is compared to the energy demand limits that may have been set through a contract that has been entered into with the respective utility company. If it is determined based on predictions that the anticipated demand exceeds the demand limits, or if it is determined by accessing on-line pricing information that energy costs are temporarily excessively high, energy controller module 24 then sends an information signal to energy control units 12 indicating that load shedding should be undertaken. Load shedding allows for a smooth and gradual reduction of illumination levels that are not noticeable by inhabitants. Studies have shown that smooth and gradual reduction of illumination levels of up to one 30% are unnoticeable to the average occupant.

Energy controller module 24 communicates with energy control units 12 through communication network 28 via the TCP/IP protocol. As a result, energy control software 24 can be operated from an authorized external personal computer via the Internet.

Personal controller module 26 is a software application that provides the same functionality as personal controller 20. The application is installed on end user computers that are connected to communication network 28. The application can be accessed directly from the desktop and allows the user to adjust light levels and recall pre-set lighting conditions. The interface for personal controller module 26 is described in further detail below.

Communication network 28 is the buildings communication network (e.g. Ethernet). No modifications are necessary to the buildings communication network (e.g. Ethernet) for use with energy management system 10, as energy management system 10 employs the standard protocols that are used by communication network 28.

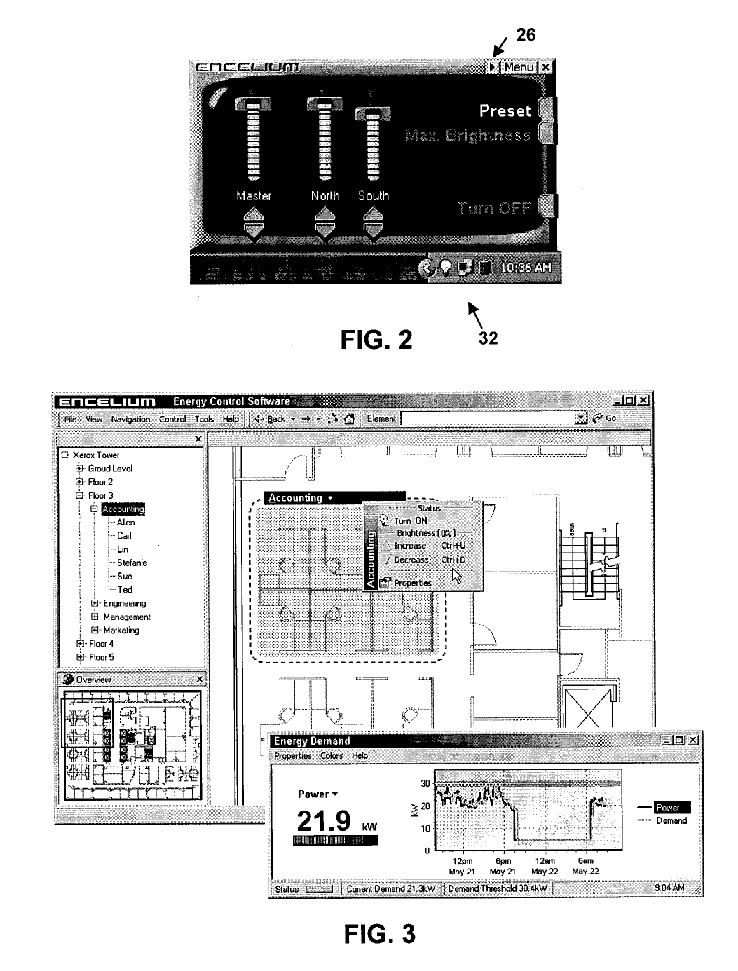

Referring now to FIG. 2, a screen shot of personal controller module 26 and its user interface is shown. Personal controller module 26 can be launched once installed on a desktop directly from the desktop taskbar. It is identified on the task bar by an incandescent bulb 32. A single click on icon 32 gives access to the main functions, in particular one is able to adjust lighting levels and recall pre-set lighting scenes. A double click on icon 32 allows the user access to set-up parameters, and custom labeling etc.

Referring now to FIG. 3, a screen shot of energy controller module 24 and its graphical user interface is shown. Energy controller module 24 and its graphical user interface provide a user with access to information regarding all aspects of energy management system 10. Since many of the strategies that are employed to increase energy efficiency are designed to operate independently, inconsistencies and occupant disturbance/discomfort and inefficiencies result when different energy reduction strategies for energy reduction are directly combined. One aspect of this, is that inefficiencies result from the improper combination of associated devices that are otherwise tailor designed to operate independently within a particular reduction strategy.

For example, if it has been determined that load shedding should be undertaken and illumination levels are reduced as a result, light sensitive sensors such as photo sensors 16, sense this reduction and attempt to counteract this effect which in essence has defeated the attempt of load shedding. Another example can be given with regards to a large open office space that shall be equipped with occupancy sensors 18 that are used to turn on lights. An occupancy sensor can only issue simple on/off requests. Especially when one sensor controls the work spaces of multiple occupants in such a scenario, the lights are turned on at a common level of illumination that is not preferred by the individual occupants and often result in excess energy usage.

In contrast, energy management system 10 allows individual sensors and other input means to provide potentially conflicting information while still maintaining and deriving an optimum level for each individual lighting fixture taking into account all inputs. Inputs from photo sensors 16, occupancy sensors 18, personal controllers 20, personal controller module 26, energy control module 24 and from various strategies (task tuning, time scheduling, load shedding, accounting for lamp lumen depreciation) and other inputs (e.g. from the building automation system) are taken into account by energy management system 10. Energy management system 10 uses a two-layer architecture that guides the flow of information and uses a four-stage process that analyzes the information appropriately. Both of these aspects of the model are described in further detail below.

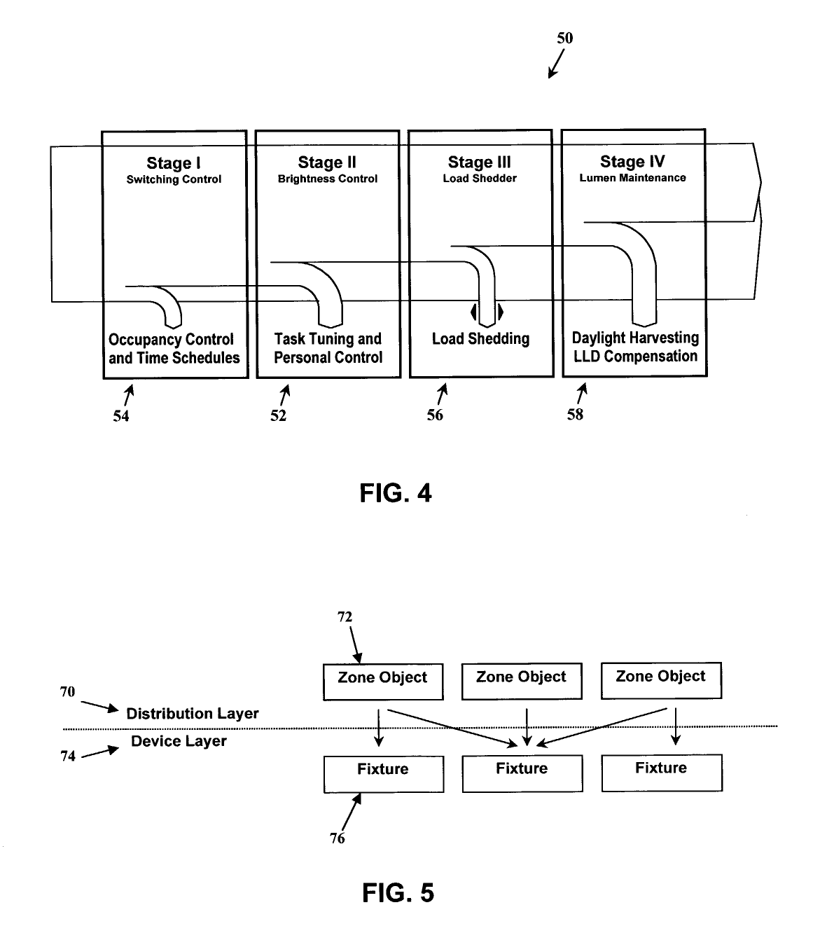

Referring now to FIG. 4, a diagram 50 representing the conceptual stages that are used to arrive at a final illumination level for one or more lighting fixtures 30 is shown. This four-stage model ensures that the various devices and strategies can contribute information so that an optimal brightness level for each light is achieved. Switching control stage 54 employs occupancy control and time scheduling strategies as will be described in order to reduce the actual on time of lighting. If it has been determined that a particular luminaire should be lit, the next stage, a brightness control stage 52 uses the task tuning information and personal control information (which may come through personal controller module 26 or personal controller 20) to pass to the next stage what the brightness of the light should be.

Once the first two stages, namely switching control stage 54 and brightness control stage 52, have arrived at a desired brightness, this desired brightness is subject to adjustment based on load shedder stage 56. As stated previously, load shedding is used based on determinations by energy controller module 24 that calculates energy usage predictions and determines whether to shed load and how much load to shed. Accordingly, the first three stages, namely brightness control stage 52, switching control stage 54 and load shedding stage 56 determine the final target brightness for a particular lighting fixture 30. Lumen maintenance stage 58 is used to maintain the final target brightness as has been determined by the previous three stages using daylight harvesting techniques which make use of natural light. For example, if the previous three stages arrived at a target illumination of 550 lux, lumen maintenance stage 58 measures the additionally available illumination through natural light and accounts for this illumination with respect to the output signal that is being sent to the lighting fixtures 30. Lumen maintenance stage 58 also compensates for the lamp lumen depreciation and the fact that fixtures accumulate dirt and lose efficiency. The implementation of these respective stages will be explained in detail with regards to architecture of energy management system 10.

Referring now to FIG. 5, it is shown that energy management system 10 has a two-layered architecture. Energy management system 10 is implemented using independent zone and fixture objects that communicate with one another via messages. The use of zone and fixture objects and messages helps to break down the system into manageable pieces and allows for flexible interconnection of objects. Messages are transmitted between hardware devices that hold the corresponding object as will be described.

As shown in FIG. 5, the first layer, a distribution layer 70 is composed of zone objects 72. Zone objects 72 can be flexibly defined. For example, a zone object can either be defined to encompass a room or a cubicle or collection of cubicles. Zones are defined using energy controller module 24. Specifically, a user can use a mouse or pointer to outline a physical area on a representative map of a building floor and define this selected area as a zone. Once such an area is selected as a zone, lighting fixtures 30 and other devices (e.g. photo sensors 16 and occupancy sensors 18) located in that area are considered to belong to that zone. Accordingly, it is possible for a room to be comprised of multiple zones.

Device layer 74 is comprised of fixture objects 76. Fixture objects 76 represent fixtures that have a distinct function and location within a building associated with them. As it is possible for zones to overlap, and as is illustrated by FIG. 5, the fixtures that are represented by fixture objects 76 may be found within multiple zones. In practice, zone objects 72 pass brightness and switching related commands down to fixture objects 76. Fixture objects 76 pass their status back up to the distribution layer 70. The output of a zone or fixture object 72 or 76 can be accessed by another object through the communication of a “data link-request” between objects.

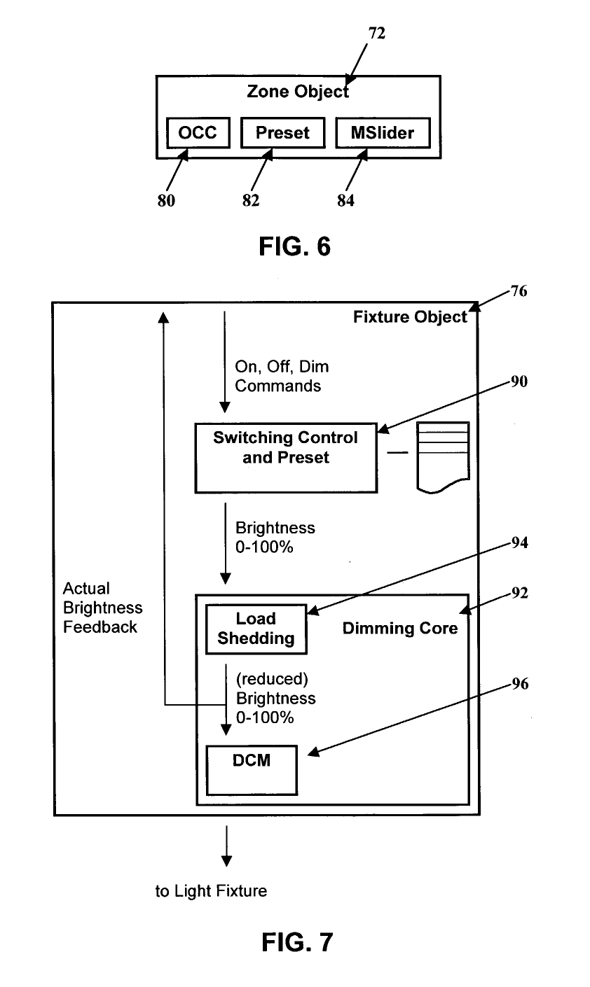

Referring now to FIG. 6, a detailed depiction of zone object 72 is shown. Zone object 72 is shown with the supporting modules it can use, namely an occupancy controller core (OCC) module 80, a preset module 82, and a master slider module 84. All of these supporting modules have a strong logical bond to a particular physical area within a building. All lighting data within a zone object 72 including the particular source of the lighting data is passed down to fixture objects 76 in device layer 74.

Occupancy controller core (OCC) module 80 receives and uses the signal of one or more occupancy sensors 18 as an indication that the physical area associated with the zone object 72 is occupied. However, occupancy controller core module 80 also looks to other elements within lighting energy management system 10 to determine whether a particular area is occupied, as will be described in further detail below.

Preset module 82 represents a particular configuration of multiple lights (e.g. a “setup” of light fixtures to provide a combination of spot and general lighting). Such preset configurations of lights generally pertain to a specific area or zone of a building (i.e. can be made to conform to the specific characteristics of a defined zone). Accordingly, they are managed by zone objects in distribution layer 70. Preset module 82 contains brightness information from the fixtures that are associated with the underlying device layer and these presets are recalled by lighting energy system 10 as needed. As will be described in further detail below, fixture objects also contain one single preset value, which will be recalled if the fixture is turned on without further specification of brightness.

Master slider module 84 is used to simultaneously represent all lighting fixtures 30 in a defined zone by a single value. For example, in a room (or zone) containing multiple lighting fixtures 30, a single brightness representation may be desired indicating how bright the room generally is, without detailing the individual brightness settings of each fixture 30 within said room. It might also be desirable to increase or decrease the overall level of illumination in said room by a certain amount, without adjusting each light fixture individually by an amount proportional to that fixture's initial brightness. In such a case, master slider module 84 controls the light output of lighting fixtures 30 within this zone so that the ratio of brightness between said fixtures is maintained. That is, not all lighting fixtures 30 have the same illumination level within a zone, as each possibly contributes different degrees of illumination to the zone, as determined by master slider module 84, towards the desired single brightness level.

Referring to FIG. 7, a representation of fixture object 76 is shown. Device layer 74 contains one fixture object 76 for each fixture. Each fixture object 76 is comprised of a number of sub-elements and modules that help it perform its functions, namely a switching control and preset module 90, a dimming core 92 comprised of a load-shedding module 94 and a daylight compensation module 96.

Switching control and preset module 90 is contained within fixture object 76 and is used to interpret and prioritize switching commands. Since fixture object 76 receives information from zone object 72 that is typically sensor dependent, it is necessary for switching control and preset module 90 to determine priorities for the information that it is receiving. Switching control and preset module 90 also receives manual commands, and is aware that manual commands (such as those requested by a user through personal controller 20 and personal controller module 26) are to be prioritized over system commands. Switching control and preset module 90 stores all requests that it receives that originate from sensors such that once one sensor withdraws the request that lights should be on, the remainder of requests can be re-prioritized and re-evaluated.

If switching control and preset module 90 determines that at least one sensor requires the light to be on, it recalls the preset lighting information that it has stored which determines the brightness of the light when it is turned on. As it is possible for two occupancy sensors 18 to be sending data that is used to determine the illumination level for the same fixture (as stated previously one fixture object can belong to different zone objects), the light is only allowed to turn off if both sensors have withdrawn their request for the lights to be kept on and there is no manual request for them to be kept on. Switching control and preset module 90 sends to dimming core module 92 the brightness level that is desired.

Dimming core module 92 further processes this information that has been received from switching control and preset module 90. Dimming core module is comprised of two modules, namely a load-shedding module 94 and a daylight compensation module (DCM) 96. It may be desirable based on economic factors to lower the brightness level that was received from switching control and preset module 90. As discussed earlier, ergonomic studies have shown that gradual load shedding (decreasing the brightness of the light) generally goes unnoticed if done smoothly.

Load shedding module 94 applies two factors to determine the final brightness level that it can maintain. Equation 1 below illustrates how the brightness level can be determined:

Brightness=DesiredBrightness−f*DesiredBrightness*(1.0−lsf) (1)

Where lsf is the load shedding factor to be applied, and f is the parameter that is lighting fixture 30 dependent. For example, a first lighting fixture 30 in a washroom may have f=2 as load shedding can be applied there where as a second lighting fixture 30 in a lobby may have f=0 as load shedding is not to affect it. Accordingly, variable f describes by how much a particular fixture is to be affected by load shedding, with f=1 being the normal. In equation 1, variable DesiredBrightness is the illumination level that has been determined prior to load shedding stage 56.

If it is has been determined that load shedding is not required (as stated previously this is determined by energy controller module 24) a load shedding factor of lsf=1.0 is applied to the brightness measure, meaning that it is left unchanged. If it is determined that load shedding is necessary, the factor that is applied is less than 1, which results in the brightness being reduced.

It is still possible at this time for a manual request to be made by a user. If for example, the user wishes to increase the illumination of a fixture, fixture object 76 first attempts to achieve the brightness level by increasing the load shedding factor lsf it applies (e.g. overriding the effects of load shedding). Once load shedding is fully compensated for, switching control and preset module 90 increases the output to the dimming core 92 to achieve the desired illumination level.

Daylight compensation module (DCM) 96 accepts the illumination level derived from load shedding module 92 and ensures that this adjusted illumination level is maintained at the fixture. Daylight compensation module 96 works in conjunction with photo sensors 16 and reduces output power to the lamps if natural light is present. The integration of photo sensors 16 into energy management system 10 is described in further detail below. Also, daylight compensation module 96 compensates for lamp lumen depreciation, the effect of lamps aging and fixtures being less efficient, by increasing output levels based on total hours that have elapsed since the last cleaning and the total hours that the lamp has burned.

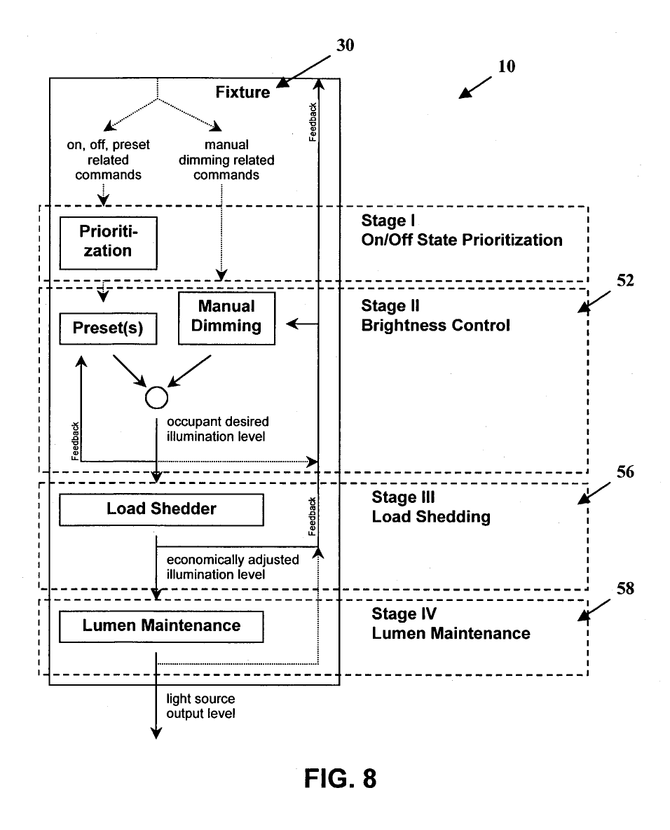

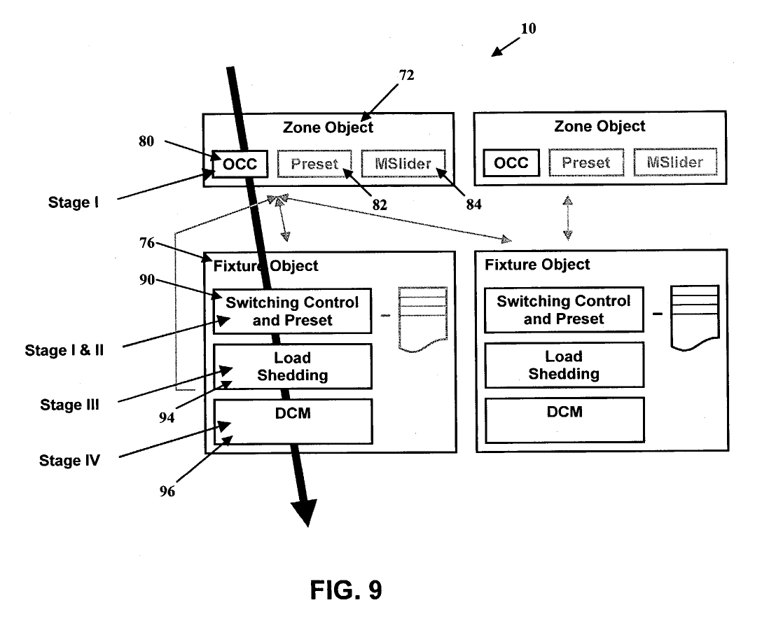

Referring now to FIGS. 8 and 9, the four conceptual stages (introduced in FIG. 4) are depicted within energy management system 10. Specifically, FIG. 8 shows how the different stages interact with one another and provide the appropriate feedback to one another. The ultimate outcome of the interaction between the stages is the desired illumination level being maintained at the respective lighting fixture 30. FIG. 9 illustrates an exemplary command process and information flow until the final brightness for fixture 30 is determined. FIG. 9 also illustrates where in the described model the four energy management system stages affect the processing of the command within energy management system 10.

Switching control stage 54 of FIG. 4 implements the time scheduling and occupancy control strategies for energy reduction and is implemented in occupancy controller core (OCC) module 80 of zone object 72. Stage 54 is also partially implemented in the command prioritization located in the switching control and preset module 90 of fixture object 76. Said switching and preset module 90 also implements brightness control stage 52. As stated previously, the objective of brightness control stage 52 is to allow for implementation of task tuning and of manual control of the illumination levels. Load shedding stage 56 is implemented in load shedding module 94 of fixture object 76, and lumen maintenance stage 58 is implemented in daylight compensation module 96 of fixture object 76.

With reference to FIG. 8, this four-stage model ensures that all sensors and inputs can contribute to the derivation of a final illumination level for each fixture. Different stages pass various types of information to each other, and this behaviour cannot be achieved by simply placing devices that allow for this computation in series or in parallel, as it would not allow for a seamless integration of the information that is coming from a vast number of inputs.

Occupancy controller core (OCC) module 80 relies on occupancy sensor 18 in order to determine the occupancy status of an area. If an occupancy sensor 18 detects that an area is unoccupied, this information is transmitted to energy control units 12. However, occupancy controller core module 80 also relies on other sources to determine occupancy status for an area. As is conventionally known, when activity has not been detected at a keyboard or mouse or other input device, energy saving means such as blanking the computer screen and/or parking the hard drive are employed. These instances are crude forms of occupancy sensing. This form of occupancy sensing can be another input to occupancy controller core 80.

Lighting energy management system 10 combines different methods of occupancy sensing in order to ensure that occupancy sensing is done in as accurate a manner as possible. As an illustration, it would be possible for a user to be almost motionless and for an associated occupancy sensor 18 to determine that the area is unoccupied. If however a computer located in the same area is in use, then the area clearly is occupied and lights should not be switched off. As another illustration, if occupancy sensor 18 determines an area as unoccupied and a computer located in the same zone is also not in use, then the computer could employ power saving means right away without a prolonged idling phase. As a result, it is advantageous to utilize other indicia when determining the occupancy status of a particular area.

A personal computer that is being used shall from time to time communicate with energy management system 10 to signal activity in a respective area. Also, a telephone system in use can be used to detect occupancy as well as access control systems (access card readers), security sensors and other systems that may be in operation within a building.

There are instances where lighting energy management system 10 does not use occupancy sensors 18 in each area due to economic reasons but rather employs purely time schedule type energy management strategies (i.e. use a pre-programmed system that turns off the lights at a certain time). When lights operating on a time schedule turn off, they flicker to warn people in the area that they are about to do so. An occupant is then required to use the light switch to signal that the lights should not turn off at their programmed time. This is essentially signaling occupancy by operating a switch. This method of warning is not required if other methods of signaling occupancy are employed.

Occupancy control core module 80 within zone object 72 collects various signs of occupancy from various sources for that zone, including computers and phones. As a result of a phone or computer being used before the lights are to be switched off, the system knows not to switch the lights off, and if a phone or computer is used before the lights are to flicker, the system knows that the area is occupied and there is no reason to cause the lights to flicker. Hence, the probability of turning lights of while a space is still occupied is reduced and consequently annoyance to occupants is reduced. Where lights have historically been turned of simply based on a time schedule basis, this turn off event can now be moved to an earlier time of the day, thus reducing energy consumption while at the same time reducing disturbances to occupants.

Photo sensors 16 are generally used in lighting control systems to allow for the harvesting of daylight. Based on the available natural light, artificial lighting is reduced to allow for a consistent level of brightness in an area. Dedicated photo sensors 16 are usually required for each zone or fixture that is to be independently controlled as daylight harvesting occurs, as they are designed for closed-loop operation. This requires a large number of photo sensors 16. Alternatively, individual control of each fixture can be limited, often resulting in limited energy consumption reductions. Also, typically special photo sensors are required that measure incident light in accordance with the human eye, requiring careful optimization of wavelength dependency. The fact that natural light and artificial light are comprised of different wavelength spectra further complicates measurements. Accordingly, photo sensors 16 are costly elements of a lighting energy efficient system.

Lighting energy management system 10 addresses all of these problems using unique calibration techniques and a small number of photo sensors 16. As an illustration of the calibration method of the present invention, consider a single photo sensor 16 installed on the ceiling above a work surface. The light readings from the photo sensor 16 are affected by a number of lighting fixtures 30. Energy management system 10 determines the photo sensor's reading profile in respect of various artificial lighting conditions, by selectively and sequentially exposing photo sensor 16 to varying levels of light from each associated light fixture 30 (i.e. for each light fixture that can affect photo sensor 16 readings).

Specifically, a first light fixture that affects the reading of the photo sensor 16 is turned on to its full level of brightness and the resulting readings from photo sensor 16 are recorded. The level of brightness of the lighting fixture 30 is reduced over a range of brightness levels and subsequent readings of photo sensor 16 are recorded for these lower levels of brightness. These steps are repeated for all light fixtures that can affect the reading of photo sensor 16. In an actual implementation of this calibration procedure, ten such brightness steps per fixture haven proven to be more than sufficient to yield high accuracy. It is contemplated that a multi-dimensional record could be obtained from this process that reflects the reading profiles of a number of photo sensors 30 in response to a plurality of lighting fixtures 30 (it is likely that more than one light fixture 30 can influence a photo sensor 16). It should be understood that natural lighting conditions should not change significantly during the calibration process (for example, calibration could be conducted at night).

The sensor measurement obtained while all surrounding light fixtures are off represents the contribution of natural light and this measurement value should be deducted from all readings obtained earlier. Ceiling mounted photo sensors always measure light reflected from a work surface and are therefore somewhat subjected to the reflection characteristic of said work surface. Therefore, a calibration factor should be obtained to translate the reading of the sensor (reflected light measurement) to natural light reaching the work surface (e.g. the factor accounts for the reflection characteristics as well as the measurement inaccuracies of the sensor element). Said calibration factor can be obtained by dividing the sensors measurement value obtained with daylight reaching the work surface but with no artificial lighting by the measurement obtained from a hand-held light meter positioned on the work surface.

Once the calibration process is completed and the reading profiles of the various photo sensors 16 have been compiled, lighting energy management system 10 calculates the contribution to the total level of lighting of artificial lighting during daylight operation (i.e. during daylight hours) based on the brightness levels sent to the light fixtures and the corresponding photo sensor 16 readings recorded during calibration for said brightness levels and the photo sensor measurement received back. Once the light portion associated with the contributing light fixtures 30 is removed from the sensor data (i.e. using the reading profiles determined during calibration), the remaining portion of the sensor reading represents the contribution of natural light.

This approach allows for energy control unit 12 to calculate natural light contribution at all times of the day and to accordingly provide constant illumination to an area even in the presence of an increase or decrease of natural light. In response to a change in natural light, energy control unit 12 automatically and suitably adjusts the output signal to individual lighting fixtures 30, each one possibly set to a different brightness, according to the real time calculated level of natural light, by subtracting (or otherwise accounting for) the natural light contribution from the output level each lighting fixture 30 would yield alone.

Since the effect of artificial lighting on the sensor's measurements has been precisely determined during calibration, and such effect can be subtracted from the measurement, the remaining purely natural contribution can be obtained and calibrated to human eye perception. In this way, the method of the present invention allows for the use of inexpensive sensing element sensors, which need not report a mixture of artificial and natural light levels as the human eye would perceive it.

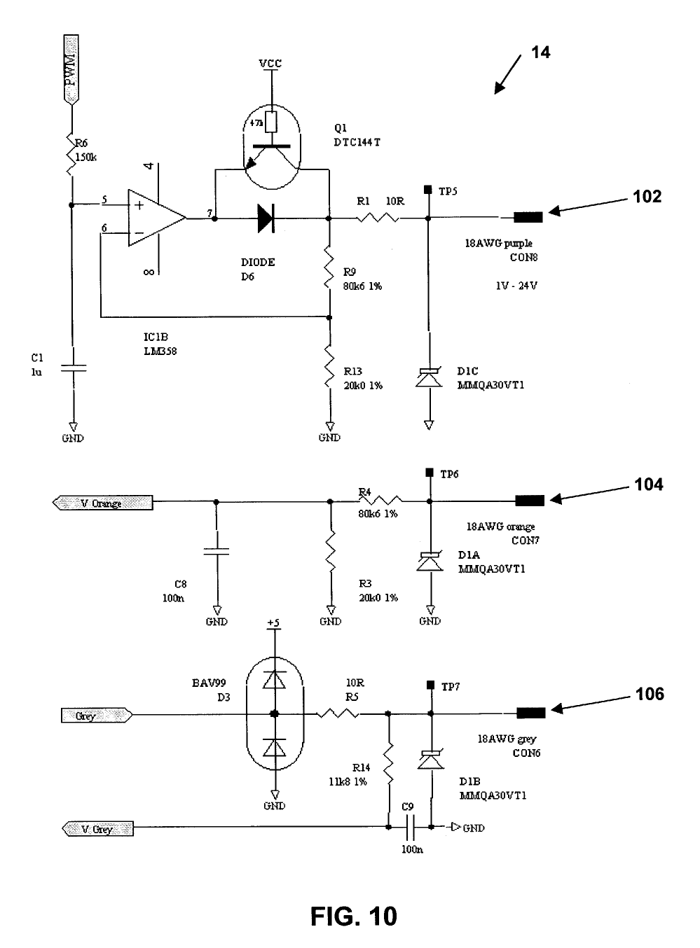

Referring now to FIG. 10, the schematic diagram of a universal input/output module 14 is shown. Input/output module 14 is a hardware device that connects communication bus 22 to all peripheral devices and lighting fixtures 30. Universal input/output module 14 has a universal three-wire interface that detects the type of device attached and automatically generates the correct interface for that device, that is, it automatically adjusts output voltages, sink and source currents and impedance on all wires as is necessary to drive the attached device and obtain information from it if applicable. This allows for reduced system complexity and installation labour as it means that universal input/output module 14 can simply be installed one after another, without regard to the requirements for different interfaces, configurations or assigning an address to each one.

Universal input/output module 14 has three terminals, a purple terminal 102, an orange terminal 104 and a gray terminal 106. Purple terminal 102 can output a variable voltage in the range of 0-24 volts and can source and sink current. Orange terminal 104 can also measure voltages in the range 0-24 V and can switch between an impedance of 10 K and 100 K. Grey terminal 106 can switch between 0V and 5V and high impedance, can measure voltage at the particular terminal and can measure current sourced or sunk by the pin.

The following example demonstrates the functionality achieved by these capabilities. A lighting fixture 30 connected to the purple and gray wire can be detected by placing gray terminal 106 in high impedance mode and then supplying a voltage of 10V, and 15V at purple terminal 102. As it is the case that a ballast/fixture operates as a voltage source of approximately 10V, grey terminal 106 would measure 0V and 5V in this case, 10V less than is applied by the purple output terminal. This characteristic is unique to a ballast. An occupancy sensor 18 may be detected by its relatively high power consumption (which can be measured by grey terminal 106). A universal interface as described therefore can distinguish between a vast selection of devices connected to it and then properly drive said detected device, and eliminate the need to design, produce, store and install dedicated interface devices for each possible sensor and output device, thereby significantly lowering cost and possibilities of incorrect installations.

Conventional and popular dimming interfaces do not turn lighting fixtures 30 completely off (i.e. they only dim down to a minimum brightness level) unless the entire circuit is turned off. Even those lighting fixtures 30 that have a “stand by” mode are still consuming and as a result wasting energy. As a result, energy management system 10 employs a small latching relay within each universal input/output module 14 which can disconnect a lighting fixture 30 from its power supply without requiring power to the entire circuit be turned off. Traditional lighting control systems typically use one powerful relay per lighting circuit to turn lighting loads on and off at a central location. The relays used in such cases are often large, heavy and costly. Electronic ballasts have capacitive input characteristics that result in enormous inrush currents of up to one hundred times the operating current. For a typical 20A circuit, such an inrush current can be 2000A, which can result in the relay contacts being welded together. The relays which have been build to withstand such inrush currents, result in high costs and are generally unreliable. Also, the resulting arrangement is cumbersome and wastes energy since when an entire circuit must be lit, it is not possible to target light only occupied areas unless the size of the circuit is reduced to the size of occupied areas which is economically unfeasible. However, in order to yield maximum energy reductions it has been found to be necessary to control lighting fixtures on a fixture-by-fixture basis.

In energy management system 10, a small relay is placed between every light fixture or its load and its associated power supply, allowing for individual switching of each lighting fixture 30. The small relays that are used are highly reliable. Commercially available relays are rated for a 16A operating current, while the operating current of single light fixture is below 1A. Accordingly, the inrush current does not exceed 100A, reducing the inrush stress from a factor of 100 to a factor of 6.25. Additionally, the impedance of the wiring between the circuit breaker and the load further reduces inrush effects. Accordingly, problems that plague the traditional high power relays, namely cost, unreliability and inefficiency from an energy management aspect can be avoided using a distributed switching arrangement.

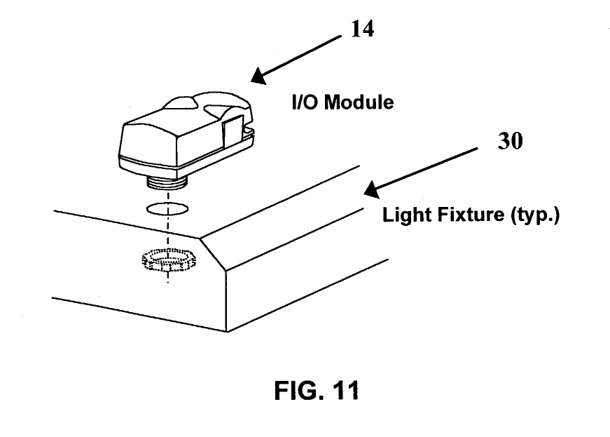

Referring now to FIG. 11, universal input/output module 14 and its mounting method to lighting fixtures 30 is shown. In most buildings, the space above the drop ceiling is used as an air-return or plenum space. There are stringent requirements in place to prevent fires in the plenum area such that smoke and toxic gasses from burning cables, wires and equipment are not injected into the air circulation, as a result, wiring for building automation systems is subject to strict standards.

Within lighting fixture 30, the primary concern is good isolation between the building automation system wiring (which generally withstands only low voltages) and the high voltages generated by the electronic dimming ballast of commonly 600V. Therefore, standards require the building automation system wiring to be at least of the same isolation breakdown voltage as the highest voltage involved. Cabling that can withstand the stringent requirements of high insulation breakdown voltage, non-flammability and good communication capabilities are virtually non existent. Typical solutions to such problems can range from using Teflon hook up wire, which is often not suitable for long distance communication and is expensive, to developing dedicated electronics to allow for communication over a low-performance, non-twisted wire, much like the AC power supply wiring itself.

Universal input/output module 30 employs a mechanical design to allow for mounting of the device by tightening a single nut through a hole that has been “knocked out” in lighting fixture 30. All communication wiring is located on the outside of lighting fixture 30 and all wires that are required to connect to lighting fixture 30 are located inside. Aside from a convenient method of mounting, as a result, a barrier (being the universal/input output module 14 itself has been extended from the lighting fixture 30 to the plenum area. Inexpensive plenum related communication cables such as Category 3 or Category 5 cabling which have a relatively low isolation breakdown voltage (and therefore don't meet electrical code requirements to penetrate the lighting fixture) but demonstrate superior characteristics for communication can thus be used to communicate to the universal input output module. Typical hook-up wiring without fire-rating and not meeting data communication requirements can be used to connect the ballast. The concept of extending the universal input/output module as part of the isolation barrier itself thus solves the problem of very high cost or not available wiring suitable for a large-scale energy management system.

Every system in a building that is designed to communicate with different nodes requires that a unique address be assigned to each node and the actual physical location of that node. Energy management system 10 allows for the grouping of lights according to a zone and/or for occupancy sensors 18 to be associated with certain lighting fixtures 30. Methods are available to solve the requirement of giving each node a unique address and are well known. However to be able to group devices together according to their location (for example, to group all fixture within one room) it is desirable that their unique address on the communication bus can be mapped to their actual physical installation location. One method to determine the physical location of nodes is for toggling each fixture on and off and locating the fixture manually on the floor and assigning it an address that is reflective of its location, this however is time consuming.

The method of the present invention automates this process resulting in fewer errors and faster commissioning time ultimately leading to a reduced system cost. The method of the present invention involves determining the wiring topology, that is, how individual devices are connected with each other and then utilizing this knowledge. Each node that has to have an address assigned to it and whose installation location needs be known in this method has the ability to a) measure its own supply voltage via the power supply cabling and b) increase its current consumption by a known amount. These requirements are implemented by a) feeding the supply voltage to an analog-digital converter and b) through using a controllable current source by connecting a fixed resistor to the micro controller, which is supplied by a linear constant voltage power supply. Nodes are represented in energy control system 10 by various sensors, fixtures and other devices that are connected to universal input/output module 14.

The method first asks all nodes to measure their power supply voltage. Then it asks one node after another to increase its current consumption by a known amount and asks all nodes to report their new supply voltage, which has been decreased due to resistive losses along the cabling. The wiring topology of all nodes is encoded in the information obtained as will be described.

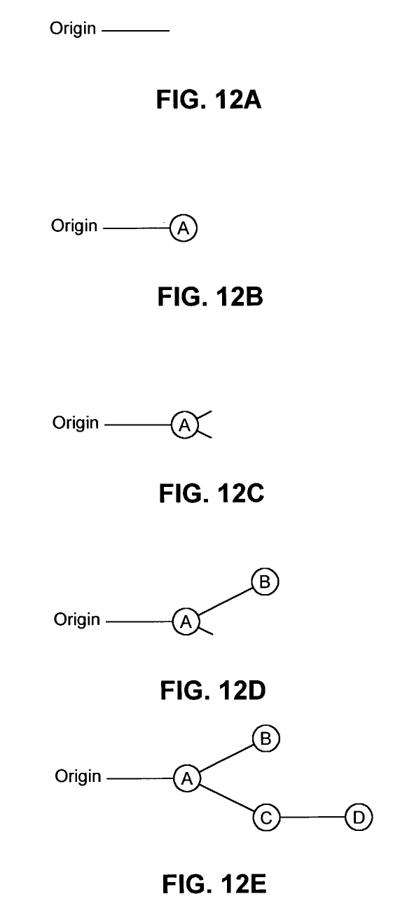

Referring now to FIGS. 12A to 12E, the method will be discussed in relation to an example topology. For the purposes of this example, the system is assumed to have four nodes (A, B, C, D). The method is used to find an address for each node and to map each node to a physical location. Assuming the physical topology shown in FIG. 12E and assuming that the wiring between the nodes is of equal length, if node C increases its current consumption, the nodes A to D will measure a reduction in supply voltage. Specifically, the supply voltage reduction for each node will be: A=1, B=1, C=2, D=2 units. One unit is equal to the voltage drop along one wire length due to the increased current. Again, it should be understood that FIG. 12E is the final derivation of the topology after this method has been applied.

The method first asks all nodes to measure their supply voltage, and this is used as a starting point. All subsequent readings that are taken are then relative to this initial reading. The method then asks a node to increase its current consumption and ask all nodes to determine by what amount their supply voltage dropped. While the reading is in volts, as resistance of the cable is proportional to its cable length and is based on Ohm's law, the difference in supply voltage is therefore proportional to cable length and commonality of cabling. The entries that are then contained in the matrix are then reflective of distances. The method is able to work with nodes connected with variable cable lengths, as the matrix would simply contain decimal numbers.

Based on these changes, a matrix (as shown below) is compiled having columns that indicates which node increased its power consumption and the rows indicating the effect (in units) as seen by the network. A matrix representing the nodes and the supply voltage drops is as follows:

| | A | B | C | D |
|---|---|---|---|---|
| A | 1 | 1 | 1 | 1 |
| B | 1 | 2 | 1 | 1 |
| C | 1 | 1 | 2 | 2 |
| D | 1 | 1 | 2 | 2 |

Each row of the matrix represents when the node of that row has its current consumption increased. The columns of that row then represent the relative voltage drops that occur at each node. The elements of the matrix while representing the voltage drops are essentially representing the commonality of the wiring between nodes. As the lower half of the matrix when taken from the diagonal on down is analyzed it does not provide information that is not available in the top part (top of the diagonal), as a result the matrix is simplified to become:

| | A | B | C | D |
|---|---|---|---|---|
| A | 1 | 1 | 1 | 1 |
| B | | 2 | 1 | 1 |
| C | | | 2 | 2 |
| D | | | | 3 |

The matrix can now be analyzed by a simple rule set which is as follows:

a) if an element on the diagonal is zero, place the node of that line in the branch diagram.

b) for each line containing a zero but not on the diagonal, create a-branch-off in the diagram with all non-zero nodes.

c) otherwise determine the minimum value of the matrix and place a cabling section of proportional length in the branch diagram, and subtract the value from all elements in the table.

Analyzing the matrix that is included above yields that rule c) is applicable. As a result, one cable length is placed from the origin (the origin in such a scenario can be the power source) as illustrated in FIG. 12A, and one unit is subtracted from all entries in the matrix, yielding the following matrix:

| | A | B | C | D |
|---|---|---|---|---|
| A | 0 | 0 | 0 | 0 |
| B | | 1 | 0 | 0 |
| C | | | 1 | 1 |
| D | | | | 2 |

Analyzing the matrix with regards to the rules yields that rule a) is applicable. As the elements that contain 0 in the matrix occur in the row for node A, node A is placed at the end of the cable wire originating from the origin as illustrated by FIG. 12B. The matrix, because node A has been used and incorporated into the topology diagram now appears as:

| | B | C | D |
|---|---|---|---|
| B | 1 | 0 | 0 |
| C | | 1 | 1 |
| D | | | 2 |

Analyzing this matrix yields the applicability of rule b), as zeros are present but not in the diagonal, two branches are created as illustrated in FIG. 12C. Applying the rules leads to the fact that one branch of the node diagram contains B and the other branch contains nodes C and D, and that two matrices now exist which need to be analyzed to give us the nodes that are to be on either side of the branch diagram.

| | B |
|---|---|
| B | 1 |

| | C | D |
|---|---|---|
| C | 1 | 1 |
| D | | 2 |

Analyzing the matrix with just node B, it is clear that rule c) applies which after subtracting the value results in rule a) applying and ultimately being represented by FIG. 12D. Analyzing the matrix with just nodes C and D yields the application of rules c), a), c), a) and its ultimate representation in the node diagram is represented in FIG. 12E.

This method allows complex topologies to be measured, and for the physical locations of such nodes to be determined with greater ease. With this method, complex topologies can be measured, which can then be used to aid the staff commissioning an area. Once the topology for a group of nodes has been determined by this method, essentially the distances between nodes are now available. After each node is assigned a specific address so that it can be communicated with, the particular type of physical device can be determined. Specifically, the particular device type can be determined from the information provided by universal input/output module 14 to energy controller module 26. Once each node has been determined to be a certain physical device (e.g. photo sensor 16, occupancy sensor 18) the devices and distances can be compared to the floor plan that was used for installation in order to determine their actual physical location so the system can be programmed with this information. So essentially with information regarding distances and type of node, addresses can be mapped to a physical location with greater ease.

It should be understood that when conducting the above-noted method of determining a wiring topology, it is possible to eliminate the step that involves increasing node current consumption by a known amount. By doing so, the method is reduced to the basic step of determining the supply voltage of each node. This determination depends on the principles of Ohm's law as applied to the wiring impedance and base current consumption of each node, as opposed to dynamically altered current consumption as is the case in the complete method.

According to this simplified method, the supply voltages of each node are determined and then sorted by magnitude. Due to resistive losses on the cabling, the supply voltage will drop with increased distance from the power supply. The assumed topology of the network would be a simple chain of nodes installed in the order of the measured supply voltage. The voltage drops can be translated into actual cable lengths if the typical power consumption of each node is known, under the simplified assumption that there are essentially no branches in the topology. If the network of nodes and cabling is constructed of cables of predetermined length, and nodes are interconnected with at least one such cable, additional conclusions can be drawn.

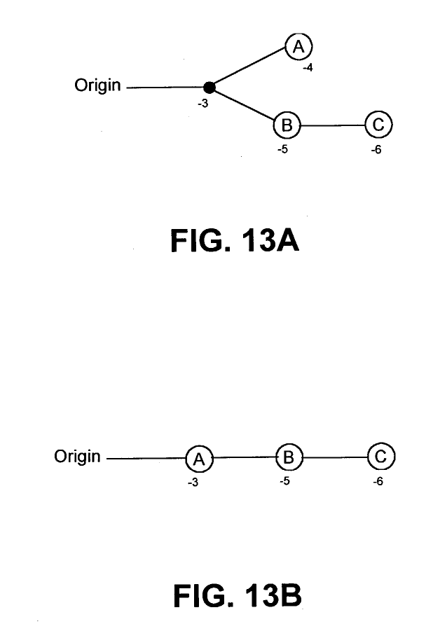

FIG. 13A illustrates the voltage drop seen by each node for an exemplary network, based on the assumption that each node consumes the same amount of current. As shown, nodes A, B and C will measure a voltage drop of 4, 5 and 6 units, respectively. In contrast, as shown in FIG. 13B, a simple chain of nodes results in different measurements. For example, node A experiences a 3 unit voltage drop in the simple chain as opposed to 4 units in the first topology. While the precise topology of a network cannot be determined based on these measurements alone, the choice of possible topologies can be narrowed.

Correlations can be made between the simple topology derived earlier and the physical construction of the floor space as derived from construction drawings. It is well known that an installer will likely first install nodes within one area before proceeding to the next area, and that they usually follow the available walkways present in those areas (i.e. avoiding obstacles such as concrete firewalls where possible).

Generally speaking, combined knowledge about some or all of the following can approximate the wiring topology of a network of nodes:

(1) the supply voltage readings of all nodes within the network; and

(2) (i) the sequence of nodes along the wiring installation as derived from said supply voltage readings sorted by magnitude; or preferably

(ii) a narrowed-down choice of possible topologies based said readings; and

(3) cable length between said nodes; and

(4) physical construction of the floor space

Especially in an interactive process where information about already commissioned nodes is taken into consideration as the process progresses, above described procedure can significantly reduce the time required to determine the physical installation location of the nodes of a network. While this simplified method results in a reduced level of automation, the process is still far superior over conventional methods.

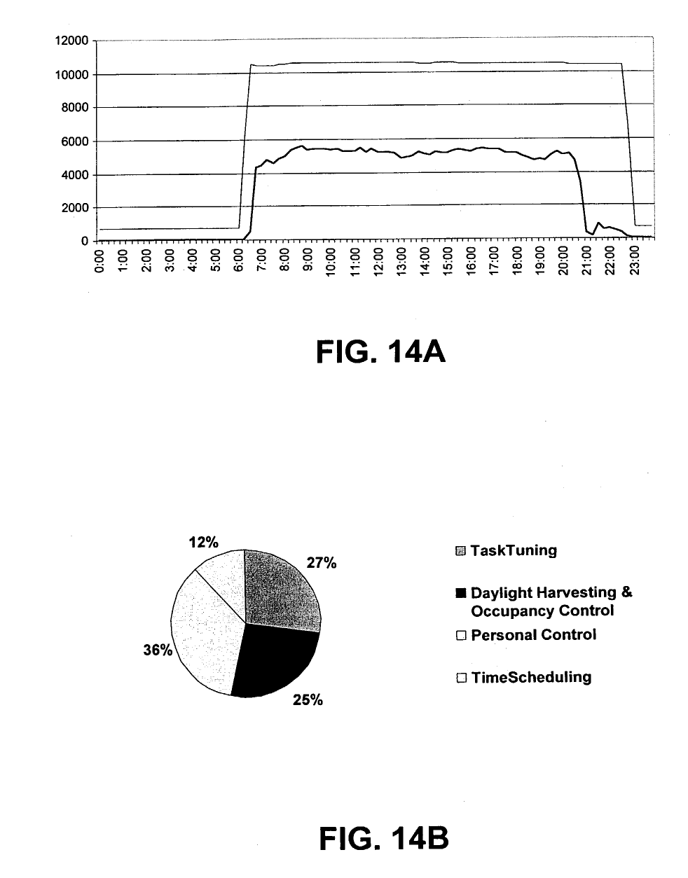

It has been determined through application of lighting energy management system 10 within a pilot site that substantial energy savings of greater than 65% can be achieved. Specifically, FIG. 14A is a graphical representation of a load diagram for actual power consumption on an average day. As can be seen, demand savings of 40% have been achieved (reducing demand from approximately 10300W to 5900W). Energy consumption, represented by surface area underneath the graph, has been reduced by 65% based on the simultaneous application of a multitude of energy management strategies, as has become possible by the presented invention.

FIG. 14B is a pie chart that illustrates the percentage contribution of the overall reduction in lighting energy consumption. Specifically, it can be seen that personal control (i.e. each occupant can adjust each lighting fixture within his vicinity to his/her personal preference) and with task tuning (i.e. the ability to adjust individual lights based on the task performed in that area) significantly contribute to the achieved energy reductions. Accordingly, it is essential that lights be controllable on a per fixture basis for these strategies to be exploited. Also, time scheduling which has been enhanced by occupancy controller core 80 of the present invention also adds substantially to overall energy reductions. It should be noted that the building was already equipped with a conventionally used time scheduling system. Overall, as can be seen from the pilot results, the coordination and management by energy management system 10 of simultaneously running various lighting energy reduction strategies result in substantial energy savings.

As will be apparent to those skilled in the art, various modifications and adaptations of the structure described above are possible without departing from the present invention, the scope of which is defined in the appended claims.

1. A lighting energy management system for controlling the operation of a plurality of lighting fixtures in a building in order to minimize the energy required by said lighting fixtures, said building having a plurality of physical zones, said energy management system comprising:
(a) at least one photo sensor for measuring a brightness level in the vicinity of the photo sensor and at least one occupancy sensor for determining whether a physical zone is occupied;
(b) a communication bus coupled to each of the lighting fixtures, photo sensors and occupancy sensors to provide data communication therebetween;
(c) a personal controller module coupled to the communication bus for generating personal lighting commands;
(d) an energy control unit coupled to the communication bus for receiving information from the photo sensors and occupancy sensors and said personal controller, determining an optimal brightness command for each lighting fixture, and providing each optimal brightness command to each lighting fixture over the communication bus, said energy control unit being adapted to store and maintain a plurality of zone objects and a plurality of fixture objects, wherein each zone object is associated with a physical or logical zone of the building and wherein each fixture object is associated with a lighting fixture and where:
(i) each said zone object has an occupancy controller module for receiving data from said at least one occupancy sensor, said occupancy controller module being adapted to selectively provide an adjustment command to associated lighting fixtures which are within the physical zone of the building associated with said zone object, so that the optimal brightness command generated by the energy control unit takes into account whether a physical zone is determined to be unoccupied;
(ii) each fixture object being associated with a zone object according to whether said associated lighting fixture is within the physical or logical zone of the building associated with the zone object, and having a switching control and preset module for obtaining data from said associated zone object, a personal controller module, to determine a desired brightness level, a load shedding module for using the desired brightness level and a load shedding factor to determine a target brightness level, and a daylight compensation module for using the target brightness level along with data from said photo sensors to determine the optimal brightness command which takes into account daylight illumination; and
(e) said energy control unit distributing the optimal brightness command received from each said fixture objects to each said associated lighting fixture, such that the energy required by the light fixtures is minimized according to various energy management strategies and personal lighting preferences.

2. The system of claim 1, wherein each fixture object is adapted to ensure that the optimal brightness command corresponds to a personal lighting command received from said personal controller module when such a personal lighting command is received.

3. The system of claim 1, wherein if a physical zone of the building is determined to be unoccupied, the adjustment command provided by the occupancy controller module of the associated zone object is such that the energy control unit generates an optimal brightness command that associated lighting fixtures are set to provide low lighting levels to allow for rapid elevation of lighting level for the physical zone, thereby eliminating the delay caused by the lamp start procedure.

4. The system of claim 1, wherein the daylight compensation module also takes into account the length of unclean operation of the light fixtures when calculating the optimal brightness command.

5. The system of claim 1, wherein said switching control and preset module also uses a predetermined time schedule to determine desired brightness levels and where occupancy controller module is activated depending on the predetermined time schedule.

6. The system of claim 1, wherein said occupancy sensor is a device selected from the group consisting of a computer program, a wall-mounted controller device, a fire alarm, a security alarm, a security sensor, an access-control device, and a telephone.

7. The system of claim 1, wherein said occupancy sensor comprises a motion detection sensor.

8. The system of claim 1, wherein the daylight compensation module of each zone object takes into account the daylight contribution to a particular lighting level as read by a photo sensor associated with at least one lighting fixture, by operating the associated light fixtures for each photo sensor at a range of brightness levels, compiling the readings of said photo sensor for each brightness level of each lighting fixture into a reading profile for the photo sensor, using said reading profile for the particular lighting level to remove the photo sensor readings associated with the brightness level associated with each lighting fixture from said lighting level, such that for the particular lighting level, the daylight contribution can be determined and wherein said energy control unit adjusts the optimal brightness command to compensate for the daylight contribution.

9. The system of claim 1, wherein each said zone object also includes a preset module for managing and associating a set of preferred brightness commands with a set of lighting fixtures, said set of preferred brightness commands being required for a specific task.

10. The system of claim 1, wherein each said zone object also includes a master slider module for associating a representative brightness level with a plurality of lighting fixture in a physical zone.

11. The system of claim 1, further comprising a plurality of input/output modules for providing an adaptive interface between the communication bus and a device, said input/output module being coupled to the communication bus and the device, each of said input/output modules comprising:
(i) a device identifier module for detecting an electrical characteristic associated with the device and determining the identity of the device based on said detected electrical characteristic; and
(ii) an universal interface module coupled to the device identifier module, said universal interface module being adapted to communicate data between said communication bus and said device, according to the identity of the device as determined by the device identifier module.

12. The system of claim 11, wherein input/output module further comprises:
(iii) a latch relay coupled to the device identifier module, said latch relay being adapted to selectively connect and disconnect said device to a power supply according to the identity of the device as determined by the device identifier module.

13. A method of controlling the operation of a plurality of lighting fixtures in a building in order to minimize the energy required by said lighting fixtures, said building having a plurality of physical zones, said energy management method comprising:
(a) determining photo sensor data using at least one photo sensor, determining occupancy data within at least one of the physical zones using at least one occupancy sensor, and providing said photo sensor data and occupancy data over a communication bus;
(b) providing signals to and from each of said lighting fixtures over the communication bus;
(c) obtaining at least one personal lighting command and providing said at least one personal lighting command over the communication bus;
(d) receiving photo sensor data, occupancy data and said at least one personal lighting commands over said communication bus, and storing and maintaining a plurality of zone objects and a plurality of fixture objects, wherein each zone object is associated with a zone of the building, each fixture object is associated with a lighting fixture and each fixture object is associated with a zone object according to whether said associated lighting fixture is within the zone of the building associated with the zone object such that:
(i) each said zone object receives occupancy sensor data and selectively provides an adjustment command to at least one associated lighting fixture, so that the optimal brightness command reduces at least one associated lighting fixture in brightness when the zone is determined to be unoccupied;
(ii) each said fixture object receives at least one of a personal lighting command and data from said associated zone object, determines a desired brightness level, uses the desired brightness level and a load shedding factor to determine a target brightness level, uses the target brightness level along with photo sensor data to determine an optimal brightness command which takes into account daylight illumination; and
(e) distributing the optimal brightness command received from each of said fixture objects to each said associated lighting fixtures, such that the energy required by the light fixtures is minimized according to several individual energy management strategies and personal lighting preferences.

14. The method of claim 13, wherein each fixture object ensures that the optimal brightness command corresponds to an associated personal lighting command when a personal lighting command is received.

15. The method of claim 13, wherein the optimal brightness command is determined in part based on the length of unclean operation of lighting fixtures.

16. The method of claim 13, wherein a predetermined time schedule is used to determine desired brightness levels and to activate the occupancy sensors depending on the predetermined time schedule.

17. The method of claim 13, wherein said occupancy sensor is a device selected from the group consisting of a personal computer-based program, a wall-mounted controller device, a fire alarm, a security alarm, a security sensor, an access-control device, and a telephone, said occupancy sensor being adapted to assess activity of said device.

18. The method of claim 13, wherein said occupancy sensor comprises a motion detection sensor.

19. The method of claim 13, wherein the daylight contribution to a particular lighting level as read by a photo sensor associated with at least one lighting fixture is determined by:
(i) operating each of the lighting fixtures at a range of brightness levels when there is no adverse change in available daylight;
(ii) compiling the readings of said photo sensor for each brightness level of each lighting fixture into a reading profile for the photo sensor; and
(iii) for the particular lighting level, using said reading profile to remove the photo sensor readings associated with the brightness level associated with each lighting fixture from said lighting level, such that for the particular lighting level, the daylight contribution can be determined;
(iv) adjusting the optimal brightness command to compensate for the daylight contribution.

20. The method of claim 13, wherein each said zone object also associates a set of optimal brightness commands with a set of multiple lighting fixtures that are required for a specific task.

21. The method of claim 13, wherein each said zone object also associates a common brightness level with all lighting fixtures in a physical zone.

22. The method of claim 13, further comprising providing an adaptive interface between the communication bus and a device by:
(i) detecting an electrical characteristic associated with the device;
(ii) determining the identity of the device based on said detected electrical characteristic; and
(iii) communicating data between said communication bus and said device, according to the identity of the device as determined by the device identifier module.

23. A method of determining the relative physical location of a plurality of device nodes interconnected with cabling within an electrical system and representing said relative physical location using a branch mapping that represents cable lengths between pairs of nodes, said method comprising:
(a) measuring the power supply voltage at each node;
(b) selectively and alternately increasing the current consumption for each node by a predetermined amount;
(c) determining the corresponding decrease in the power supply voltage within said node and said other nodes that results due to resistive losses within the cabling; and
(d) determining the physical cable length between each pair of said nodes and the relative physical location of each of said nodes.

24. The method of claim 23, further comprising:
(e) compiling a square matrix having a dimension equal to the number of nodes, each element of said matrix having a column node and a row node wherein the value of said element is equal to the decrease in power supply voltage for the device associated with one of the row and column node when the current consumption for the device associated with one of the row and column node is increased;
(f) performing the following matrix reduction operations:
(i) placing the node in a branch diagram if the corresponding row or column element on the matrix diagonal is zero;
(ii) creating a branch-off in the diagram for the node if the corresponding row or column element on the matrix diagonal is non-zero and if there is a zero elsewhere in the corresponding row or column;
(iii) if the conditions in (i) and (ii) are true then determining the minimum value of the matrix, placing a cabling section of corresponding length in the branch diagram and subtracting the minimum value from all elements; and
(iv) repeating steps (i) to (iii) until all nodes have been represented in the branch mapping.

25. The method of claim 23, wherein all cable lengths between adjacent nodes are of fixed length.

26. The method of claim 23, wherein at least one of said cable lengths between adjacent nodes are of variable length.

27. The method of claim 23, wherein said nodes are attached to a plurality of devices, wherein said device is located on an architectural floor plan, said method further comprising:
(i) applying the branch mapping to determine the physical distance between each of said nodes and said associated devices; and
(ii) associating each device with a location on the architectural floor plan.

28. A method of determining the relative physical location of a plurality of device nodes interconnected with cabling within an electrical system and representing said relative physical location, said method comprising:
(a) measuring the power supply voltage at each device node,
(b) sorting said power supply measurements and determining a sequence of physical installation locations based on the sorted power supply measurements;
(c) comparing said sequence with a likely sequence of installation based on the physical construction of said electrical system;
(d) determining the relative physical location of each of said nodes.

29. The method of claim 28, wherein step (b) includes the sorting of said power supply measurements by magnitude.

30. The method of claim 28, wherein step (b) includes the step of sorting said power supply measurements by comparing said power supply measurements with measurements derived from reference topologies.

31. A system for interconnecting a plurality of devices, said system including a communication bus and a plurality of input/output modules coupled to the communication bus and to each device, each said input/output module being adapted to provide an adaptive interface between the communication bus and each device, each of said input/output modules comprising:
(i) a device identifier module for detecting an electrical characteristic associated with the device and determining the identity of the device based on said detected electrical characteristic; and
(ii) a universal interface module coupled to the device identifier module, said universal interface module being adapted to communicate data between said communication bus and said device, according to the identity of the device as determined by the device identifier module.

32. The system of claim 31, wherein input/output module further comprises:
(iii) a latch relay coupled to the device identifier module, said latch relay being adapted to selectively connect and disconnect said device to a device power supply according to the identity of the device as determined by the device identifier module.

33. A method of interconnecting a plurality of electrical devices, said system including a communication bus and a plurality of input/output modules coupled to the communication bus and to each device, each said input/output module being adapted to provide an adaptive interface between the communication bus and each device, said method comprising:
(i) detecting an electrical characteristic associated with the device and determining the identity of the device based on said detected electrical characteristic; and
(ii) communicating data between said communication bus and said device, according to the identity of the device as determined by the device identifier module.

34. The method of claim 33, further comprising:
(iii) selectively connecting and disconnecting said device to a device power supply according to the identity of the device as determined in step (i).

35. An energy management system for controlling the operation of a plurality of energy consuming units in a building in order to minimize the energy required by said energy consuming units, said building having a plurality of physical zones, said energy management system comprising:
(a) a sensor located in a physical zone of the building, said sensor being selected from the group consisting of a computer program, a wall-mounted controller device, a fire alarm, a security alarm, a security sensor, an access-control device, and a telephone, each of which provides an operational signal; and
(b) an occupancy controller module associated with the physical zone of the building coupled to the sensor for receiving data concerning the occupancy of a physical zone, said occupancy controller module being adapted to detect said operational signal associated with said sensor and to determine whether a physical zone is occupied based on said operational signal.

36. The system of claim 35, wherein said occupancy controller module utilizes said operational signal to ensure energy consuming units remain operational when a physical zone is determined to be occupied.

37. A method of performing daylight compensation within a lighting energy management system wherein the daylight contribution to a particular lighting level as read by a photo sensor associated with at least one lighting fixture is determined by:
(i) operating each of the lighting fixtures at a range of brightness levels when there is no adverse change in available daylight;
(ii) compiling the readings of said photo sensor for each brightness level of each lighting fixture into a reading profile for the photo sensor; and
(iii) for the particular lighting level, using said reading profile to remove the photo sensor readings associated with the brightness level for each lighting fixture from said lighting level, such that for the particular lighting level, the daylight contribution can be determined;
(iv) adjusting the light provided by each lighting fixture to compensate for the daylight contribution as determined in step (iii).

38. A method of controlling the operation of a plurality of energy consuming units in a building using a plurality of local switching devices that reduces switching stress due to excessive inrush currents normally associated with said energy consuming units and reduces energy consumption, each energy consuming unit having an associated power supply and an inrush current limiting impedance, said method comprising:
(a) distributing the centralized switching control by electrically coupling each of said local switching devices between an associated energy consuming unit and an associated power supply;
(b) locating each of said switching devices in close proximity to each of said energy consuming units so as to increase inrush current limiting impedance associated with said energy consuming unit;
(c) communicating a connectivity command to said switching devices over a communication bus; and
(d) selectively switching each energy consuming unit using said switching device based on the connectivity command.

39. The method of claim 38, wherein each said switching device is a latching relay.

40. A method of installing a lighting control device and associated data communication wiring and power wiring within a lighting fixture cover having knock-out aperture formed within, said method comprising:
(a) installing said data communication wiring outside said lighting fixture cover above the position of said knock-out aperture;
(b) installing said power wiring within said fixture cover below the position of said knock-out aperture; and
(c) positioning and removeably securing said lighting control device within said knock-out aperture such that said lighting control device represents an electrical barrier between the inside of said light fixture cover and the outside of said light fixture cover.
